(19) United States
(12) Patent Application Publication
(10) Pub. No.: US 2009/0191998 A1
(43) Pub. Date: Jul. 30, 2009

(54) Toothed belt drive for the use with oil

(76) Inventors: Marco Di Meco, Pescara (IT); Massimiliano Delli Rocioli, Montesilvano (IT); Carlo Fiordaliso, Sant'Angelo (IT)

Correspondence Address: MITCHELL P. BROOK;LUCE, FORWARD, HAMILTON & SCRIPPS LLP, 11988 EL CAMINO REAL, SUITE 200, SAN DIEGO, CA, 92130, US

(21) Appl. No.: 11/664,042

(22) PCT Filed: Sep. 29, 2004
(86) PCT No.: PCT/IT05/00534

§ 371 Date: Mar. 28, 2007

(51) Int. Cl. F16G 1/28; F16H 55/17

(52) U.S. Cl. 474/153

(57) ABSTRACT

Toothed belt drive for use with oil, comprising at least a pair of toothed pulleys and a toothed belt meshing with the pulleys, wherein the toothing of the belt and the toothing of each of the pulleys have respective reference profiles with infinite radius pitch line so that the transverse clearance between a tooth of the reference profile of the belt and a groove of the reference profile of a pulley is between −0.1 mm and +0.15 mm at least in an intermediate portion of the respective sides.

### TECHNICAL FIELD

The present invention relates to a toothed belt drive for use with oil. Preferably, although not exclusively, the invention can be applied in timing systems of internal combustion engines for motor vehicles, which shall be referred to hereunder for greater clarity, without however losing generality.

### BACKGROUND ART

In internal combustion engines, control of timing, that is, synchronous driving of the camshaft or camshafts by the drive shaft, is generally performed by a toothed belt or a chain. Toothed belts have some advantages with respect to chain drives: they are less expensive, lighter, and they can operate dry, which normally makes the entire drive more simple and inexpensive.

Moreover, elongation through time of the belts is lower than chains, which are subject to wear of the pins. Finally, belt drives are normally more silent than chain drives.

In view of the aforesaid advantages of toothed belt drives with respect to chain drives, the use of toothed belt drives may be advantageous not only in dry applications but also in environments exposed to lubricating oil; however, the use of a toothed belt in an application in which oil is present determines a series of technical problems that are difficult to solve.

To begin with, it has been found that the profiles of the teeth of the belt and of the pulleys normally used for dry applications cause, when oil is present, an increase in timing errors between the driven member (camshaft) and the driving member (drive shaft).

Another problem related to the use of toothed belts with oil concerns the aggressive action of the oil on the belt materials, and in particular the difficulty in maintaining through time adhesion between the elastomeric material constituting the body of the belt and the resistant inserts (cords) embedded in this material.

### DISCLOSURE OF INVENTION

The object of the present invention is to produce a toothed belt drive for use with oil, which makes it possible to solve the aforesaid problems, and in particular guarantees a high level of timing precision between the driving and driven members of the drive and increased duration of the belt.

The aforesaid object is obtained by a drive as claimed in claim 1.

### BRIEF DESCRIPTION OF THE DRAWINGS

For a better understanding of the present invention, a preferred embodiment is described below by way of a non-limiting example and with reference to the accompanying drawings, wherein:

FIG. 1 shows a scheme of a belt drive according to the present invention;

FIG. 2 is a perspective and partial view of a belt of the drive according to the invention;

FIG. 3 shows the ratio between a reference profile of the belt and a reference profile of a pulley of the drive according to the invention.

### BEST MODE FOR CARRYING OUT THE INVENTION

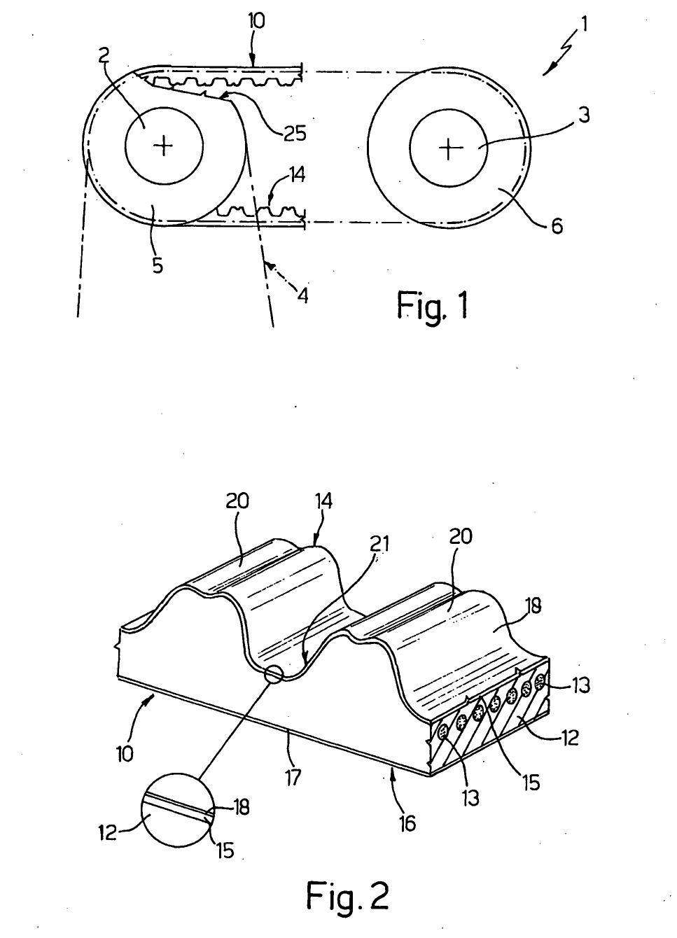

With reference to FIG. 1, a synchronous toothed belt drive for transferring motion from a first camshaft 2 to a second camshaft 3 of an internal combustion engine is indicated as a whole with the number 1. The first camshaft, in turn, takes its motion from the drive shaft (not shown) through another synchronous drive 4, preferably of the same type, shown only schematically and partially in FIG. 1.

The drive 1, known as “cam-to-cam”, comprises a toothed driving pulley 5 keyed onto the camshaft 2, a toothed driven pulley 6 keyed onto the camshaft 3 and a toothed belt 10 wound on the pulleys 5, 6.

The belt 10 (FIG. 2) comprises a body 12 made of elastomeric material, embedded in which are a plurality of longitudinal filiform resistant inserts 13. The body 12 has a first side provided with toothing 14, which is covered by a coating fabric 15, and a second side or back 16 of the belt. Preferably, the back 16 is also covered by a fabric 17.

Still more preferably, the fabric 15 which coats the toothing 14 is the same as the fabric 17 which coats the back 16. Preferably, the body 12 comprises as main elastomer, that is, present for more than 50 weight % with respect to the other elastomers used in the mix, a copolymer formed from a monomer containing nitrile groups and from a diene.

More preferably the copolymer used is hydrogenated acrylonitrile butadiene.

Preferably, the copolymer used is obtained from monomers containing nitrile groups in a percentage between 33% and 49 weight % with respect to the final copolymer.

Still more preferably, the copolymer used is obtained from monomers containing nitrile groups in a weight percentage of 39% with respect to the final copolymer, for example it is possible to use a mixture constituted by 50% of THERBAN 3446 (Bayer registered trademark) and by 50% of THERBAN 4307 (Bayer registered trademark).

Advantageously the elastomeric material mixture also comprises fibres, preferably in a weight percentage between 0.5% and 15% with respect to the elastomeric material and preferably having a length between 0.1 and 10 mm.

The fabric 15 coating the toothing 14 or the fabric 17 coating the back 16 can be constituted by one or more layers and can for example be obtained by means of the weaving technique known as 2×2 twill.

The fabrics 15, 17 are preferably constituted by a polymeric material, preferably aliphatic or aromatic polyamide, still more preferably by high thermal resistance and high tenacity polyamide 6.6.

The fabrics 15, 17 can advantageously be of the type wherein each weft thread is constituted by an elastic thread as core and by at least one composite thread wound on the elastic thread, where the composite thread comprises a high thermal and mechanical resistance thread and at least one coating thread wound on the high thermal and mechanical resistance thread.

According to one feature of the present invention, the toothed belt 10 comprises a resistant layer 18 disposed externally to the fabric 15.

The resistant layer 18 is constituted by a fluorinated plastomer with the addition of an elastomeric material, the amount of fluorinated plastomer being greater, in weight, with respect to the elastomeric material.

An example of resistant layer usable is for example described in the patent EP1157813 to the same applicant.

The fluorinated plastomer is preferably a mix based on polytetrafluoroethylene.

Preferably, the elastomeric material with which the fluorinated plastomer is mixed to form the resistant layer 18 is HNBR, still more preferably HNBR modified with a zinc salt of polymethacrylic acid, for example ZEOFORTE ZSC (Nippon Zeon registered trademark).

Preferably, to ensure the necessary resistance the resistant layer 18 has a weight between 150 and 400 g/m2, equivalent to a mean thickness between 0.050 and 1 mm.

Preferably, the fluorinated plastomer is present in amounts between 101 and 150 in weight per 100 parts of elastomeric material.

The resistant layer 18 also comprises a peroxide as vulcanizing agent. The peroxide is normally added in amounts between 1 and 15 parts in weight with respect to 100 parts of elastomeric material.

Preferably, an adhesive material is disposed between the coating fabric 15 and the resistant layer 18.

The resistant inserts 13 are produced in one or more materials chosen in the group constituted by glass fibres, aramid fibres, polyester fibres, carbon fibres and PBO fibres.

Preferably, the resistant inserts 13 are of the “hybrid” type, that is, they are produced in at least two different materials.

The first material is preferably glass fibre, the second material is preferably carbon fibre. Still more preferably, the glass fibres are high modulus fibres.

The glass fibres are wound around the carbon fibres to cover the carbon fibres externally at least partially and preferably to cover the carbon fibres entirely.

The resistant inserts 13 are preferably treated with a resorcinol-formaldehyde latex based composition, known as RFL, and in particular with an RFL composition suitable to prevent oil absorption. Preferably, the RFL used therefore comprises a latex formed from a monomer containing nitrile groups and from a diene, for example HNBR or hydrogenated butadiene acrylonitrile. Still more preferably, the latex is obtained from monomers containing nitrile groups in a weight percentage with respect to the final copolymer similar to the preferred elastomeric material used to form the body 12 of the toothed belt 10 described previously.

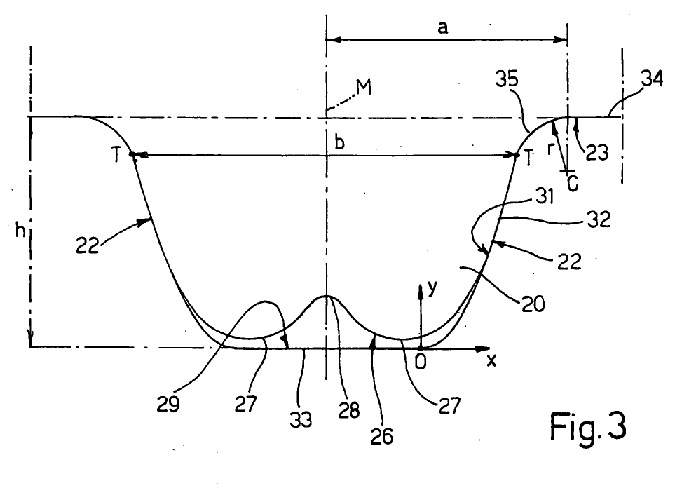

The toothing 14 of the belt 10 is defined by a succession of teeth 20 and grooves 21 and has a geometry of conventional type. FIG. 3 shows the profile of the toothing 14 in a rectilinear configuration of the belt 10 (that is, in the configuration taken by the belt in the sections between the pulleys, geometrically similar to racks). This profile is indicated hereunder in the description and in the claims as “reference profile with an infinite curvature radius pitch line” or, more briefly, “reference profile”.

For example, the profile of the teeth 20 of the belt 14 can be the one marketed by the applicant with the name ISORAN® RHP®, with parabolic sides 22, each connected, at the bottom surface 23 of the adjacent groove 21 by an arc of circumference 24; the teeth 20 conveniently have a top surface 26 defined by two convex protrusions 27, for example with the profile describing an arc of circumference, each connected to a respective side 22 and to each other by a concave arc 28, for example an arc of circumference.

The pulleys 5, 6 are provided with respective identical toothings, each defined by a succession of grooves 29, suitable to receive the teeth 20 of the belt 10, and of teeth 30, suitable to engage the grooves 21 of the belt 10.

Also with regard to the pulleys 5, 6, the profile of the toothing is described, and shown in FIG. 3, having recourse to a reference profile with an infinite curvature radius pitch line, that is, to the profile of the toothing of an equivalent rack or to the “negative” of the profile of a hob for cutting the pulleys 5, 6.

The use of equivalent profiles of the belt and of the pulley allows a direct comparison to be made between the profiles (FIG. 3), notwithstanding the number of teeth of the pulleys and, therefore, the pitch line radius of the belt 10 in the portions thereof meshing with the pulleys 5, 6.

The profile of each of the grooves 28 is symmetrical with respect to a centre line M; therefore, only one of the sides 31 of a groove 29 is described.

The side 31, in a known way, is defined by a concave arc of parabola 32 connected to a base line 33 and to a top line 34. In particular, the arc of parabola has the equation:

y=kx²

in a system of Cartesian axes x, y in which x is the coordinate parallel to the base line 33 and y is the coordinate parallel to the height of the groove 29, and originates in a point O on the base line 33 constituting both the vertex of the parabola, and the connection point between the arc of parabola 32 and the base line 33 (FIG. 3). The arc of parabola 32 is connected to the top line 34 by an arc of circumference 35 with radius r and centre C, having a distance from the top line 34 equal to r. The tangent point between the arc of parabola 32 and the arc of circumference 35 is indicated with T. Also indicated are the distance of the point C from the centre line M of the groove with a, the width of the groove 29 measured at the height of the points T on the two sides of the groove with b, and the height of the groove, i.e. the distance between the base line 33 and the top line 34, with h.

According to the present invention, the transverse clearance between a tooth of the reference profile of the belt and a groove of the reference profile of a pulley in an intermediate portion of the respective sides ranging from 1/5 to 4/5 of the height of the tooth is between −0.1 mm and +0.15 mm; a negative value of clearance identifies a condition of interference.

Preferably, this clearance is between −0.05 mm and 0.1 mm. Still more preferably, said clearance is equal to 0.

Purely as an example, the latter of the aforesaid conditions, for a belt with conventional ISORAN® RHP® profile, is obtained with the following values of the groove parameters:

k=1.49633
h=2.92 mm
a=3.264 mm
b=5.30 mm

In FIG. 3 it can be seen how in the example described there is essential identity between the reference profile of the pulley and the reference profile of the belt, with the exception of the area corresponding to the top portion of the tooth.

Although in this example there is essentially zero clearance in the entire intermediate portion of the sides ranging from 1/5 to 4/5 of the height of the tooth, according to the present invention this condition is not necessary, it being sufficient, in at least one section of the aforesaid intermediate portion, for transverse clearance to be in the aforesaid range and, preferably, essentially zero.

According to the present invention, the use of a coating fabric provided with a resistant layer based on a fluorinated plastomer with the addition of an elastomeric material, in combination with dimensioning of the toothings that determines an essentially low or zero clearance between the teeth of the belt and the grooves of the pulleys, makes it possible, in use with oil, to considerably reduce timing errors between the driving member and the driven member without however reducing the duration of the belt.

For example, a drive according to the invention was used to connect the camshafts of an IVECO UNIJET HPI 2.3 litre “Common Rail” engine to each other. Tests performed produced maximum timing errors between the two shafts equivalent to 0.5° at 3000 rpm; tests performed in identical conditions but using a conventional belt and pulley (RHP standard profile) produced maximum errors equal to 0.95°.

The increase in timing errors found in applications in which oil is present using profiles of conventional type is essentially due to the reduction in the belt/pulley coefficient of friction due to the presence of an oil gap in the meshing areas.

The use of a resistant layer based on a fluorinated plastomer, although contributing towards further reducing the coefficient of friction, makes it possible to produce very precise meshing between the toothings of the belt and of the pulleys, that is, with reduced or zero clearance, without compromising the duration of the belt.

Therefore, the combination between the use of the aforesaid layer and the coupling precision between the toothings surprisingly makes it possible to solve the problems of known art.

Moreover, this layer protects the belt from the oil permeation and thereby limits the aggressive effects thereof, in particular the negative effects on adhesion between elastomeric material and resistant inserts.

Finally, it is clear that the drive described can be subjected to modifications and variants, without however departing from the scope defined by the claims.

In particular, the materials constituting the body of the belt, the resistant inserts, the coating fabric and the profile of the toothings can change.

1. Toothed belt drive for use with oil comprising at least a pair of pulleys having respective toothings and a toothed belt meshing with the pulleys, the belt comprising a body made of elastomeric material, a plurality of filiform resistant inserts embedded in the body, and a toothing provided with a coating fabric, characterized in that the toothing of the belt and the toothing of each of the pulleys have respective reference profiles with an infinite curvature radius pitch line so that the transverse clearance between a tooth of the reference profile of the belt and a groove of the reference profile of a pulley is between −0.1 mm and +0.15 mm at least in an intermediate portion of the respective sides ranging from 1/5 to 4/5 of the height of the tooth, and in that said coating fabric is covered with a resistant layer comprising a fluorinated plastomer with the addition of an elastomeric material.

2. Drive as claimed in claim 1, characterized in that said clearance is between −0.05 mm and +0.10 mm.

3. Drive as claimed in claim 1, characterized in that said clearance is essentially equal to zero.

4. Drive as claimed in claim 1, characterized in that in said resistant layer the amount of fluorinated plastomer is greater, in weight, with respect to the elastomeric material.

5. Drive as claimed in claim 1, characterized in that the fluorinated plastomer is a compound based on polytetrafluoroethylene.

6. Drive as claimed in claim 1, characterized in that said elastomeric material with which the fluorinated plastomer is mixed to form the resistant layer comprises an HNBR.

7. Drive as claimed in claim 6, characterized in that said elastomeric material is an HNBR modified with a zinc salt of polymethacrylic acid.

8. Drive as claimed in claim 1, characterized in that said resistant inserts of said belt are constituted by at least a material chosen in the group comprising glass fibres, aramid fibres, polyester fibres, carbon fibres and PBO fibres.

9. Drive as claimed in claim 8, characterized in that said resistant inserts comprise glass fibres and carbon fibres.

10. Drive as claimed in claim 1, characterized in that said resistant inserts are treated with an RFL comprising a latex formed from a monomer containing nitrile groups and from a diene.
